(19) United States
(12) Patent Application Publication
(10) Pub. No.: US 2007/0300148 A1
(43) Pub. Date: Dec. 27, 2007

(54) METHOD, SYSTEM AND COMPUTER PROGRAM PRODUCT FOR CREATING A RESUME

(76) Inventors: Chris Aniszczyk, Austin, TX (US); Terence Kiprop Chesire, Cambridge, MA (US); Phillip Matthew Crosby, Westminster, MD (US); Bryan Estrada, San Luis Obispo, CA (US); Mark William Weaver, Costa Mesa, CA (US); Eric Joseph Wood, Santa Cruz, CA (US)

Correspondence Address: IBM CORP (YA);C/O YEE & ASSOCIATES PC, P.O. BOX 802333, DALLAS, TX, 75380, US

(21) Appl. No.: 11/426,629

(22) Filed: Jun. 27, 2006

(51) Int. Cl. G06F 17/00; G06F 17/30

(52) U.S. Cl. 715/513; 715/530; 715/500; 707/1

(57) ABSTRACT

Computer implemented method, system and computer program product for creating a resume that facilitates generating and updating multiple versions of the resume. A computer implemented method for creating a resume includes storing resume information. Rules are specified by which a resume for a particular job application is to be created, and the stored resume information is parsed according to the specified rules to provide specified resume information. A resume is then created for the particular job application from the specified resume information.

### BACKGROUND OF THE INVENTION

1. Field of the Invention

The present invention relates generally to the data processing field and, more particularly, to a computer implemented method, system and computer program product for creating a resume that facilitates generating and updating multiple versions of the resume.

2. Description of the Related Art

Prospective employers often require a job applicant to provide a resume that is in a particular format and/or that contains specific types of information. For example, one prospective employer may require a resume that describes prior work experience in substantial detail, while another prospective employer may request a short, one page resume that merely lists prior employment. Conversely, a job applicant may wish to provide different resumes to different prospective employers. For example, a job applicant may wish to emphasize job skills differently to different prospective employers such as by changing the order of listed job skills or the like.

Because a resume must frequently be “customized” for particular job applications, a job applicant often ends up with numerous versions of his/her resume. These numerous versions are time consuming to prepare and difficult to organize and maintain.

Typically, multiple versions of a resume will contain common information such as the job applicant's address and phone numbers. It is also a troublesome and time consuming project to update all the versions of the resume to reflect changes that may occur, from time to time, in this common information.

It would, accordingly, be desirable to provide a mechanism for creating a resume that facilitates generating and updating multiple versions of the resume.

### SUMMARY OF THE INVENTION

Illustrative embodiments provide a computer implemented method, system and computer program product for creating a resume that facilitates generating and updating multiple versions of the resume. A computer implemented method for creating a resume includes storing resume information. Rules are specified by which a resume for a particular job application is to be created, and the stored resume information is parsed according to the specified rules to provide specified resume information. A resume is then created for the particular job application from the specified resume information.

### BRIEF DESCRIPTION OF THE DRAWINGS

The novel features believed characteristic of the illustrative embodiments are set forth in the appended claims. The illustrative embodiments, however, as well as a preferred mode of use, further objectives and advantages thereof, will best be understood by reference to the following detailed description of the illustrative embodiments when read in conjunction with the accompanying drawings, wherein:

FIG. 1 depicts a pictorial representation of a network of data processing systems in which aspects of illustrative embodiments may be implemented;

FIG. 2 is a block diagram of a data processing system in which aspects of illustrative embodiments may be implemented;

FIG. 3 is a block diagram that schematically illustrates a system for creating a resume according to an illustrative embodiment;

FIGS. 4A and 4B illustrate examples of portions of annotated XML resume data according to an illustrative embodiment; and

FIG. 5 is a flowchart that illustrates a method for creating a resume according to an illustrative embodiment.

### DETAILED DESCRIPTION OF THE PREFERRED EMBODIMENT

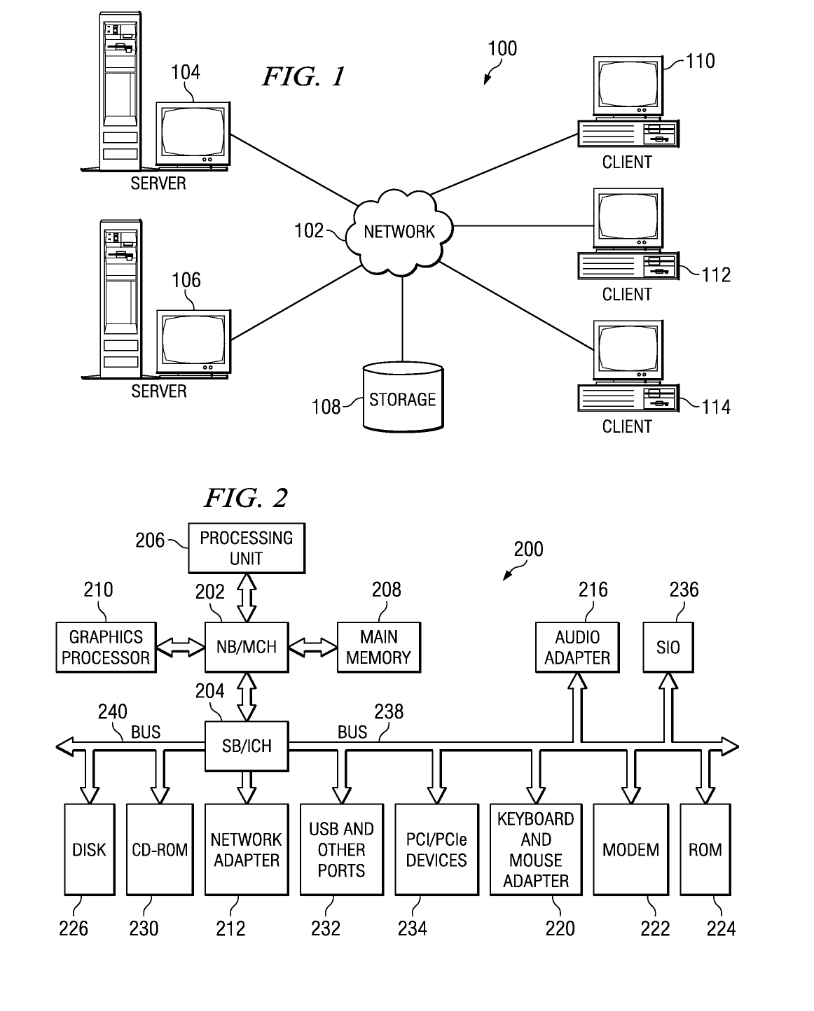

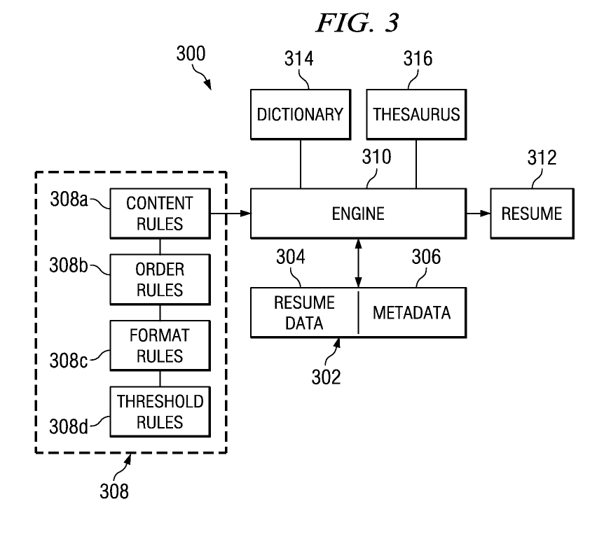

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

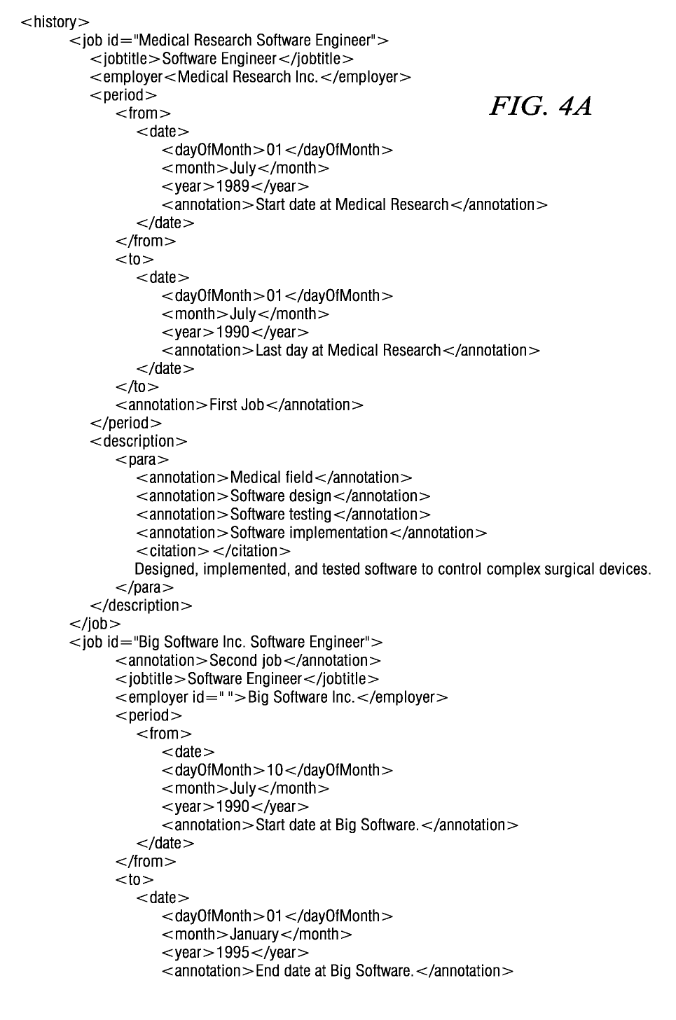

Illustrative embodiments provide a computer implemented method, system and computer program product for creating a resume that facilitates generating and updating multiple versions of the resume. FIG. 3 is a block diagram that schematically illustrates a system for creating a resume according to an illustrative embodiment. The system is generally designated by reference number 300 and may be implemented in data processing system 200 illustrated in FIG. 2.

System 300 includes annotated resume information 302 which is preferably stored as an annotated XML (Extensible Markup Language) document. Annotated XML document 302 includes stored resume data 304 and metadata 306. As will be described more fully hereinafter, stored resume data 304 includes all of the information that an individual might want to include in a resume, while metadata 306 includes information about the stored resume data, and assists in creating an appropriate resume for a particular job application from the stored resume data.

System 300 also includes rules 308. Rules 308 comprises a set of rules which specifies the manner in which the stored resume data and the metadata are to be used to create an appropriate resume for a particular job application. In the illustrative embodiment shown in FIG. 3, rules 308 include content rules 308a relating to the content of a resume to be created, ordering rules 308b relating to the order in which information is to be presented in the resume to be created, format rules 308c specifying the format of the resume to be created, and threshold rules 308d specifying minimum requirements for a resume to be created for a particular job application. It should be understood that rules 308a-308d, which will be described more fully hereinafter in connection with various examples, are intended to be exemplary only of the types of rules that can be specified to create an appropriate resume, and it is not intended to limit the illustrative embodiments to any particular types of rules.

System 300 also includes engine 310. Engine 310 searches through stored annotated XML document 302 and creates resume 312 from stored resume data 304 with the assistance of metadata 306 that is “customized” for a particular job application pursuant to rules 308 specified for that particular job application. As further shown in FIG. 3, and as will be explained more fully hereinafter, system 300 may also include additional components such as dictionary 314 and thesaurus 316 to assist in preparing an effective, high quality resume.

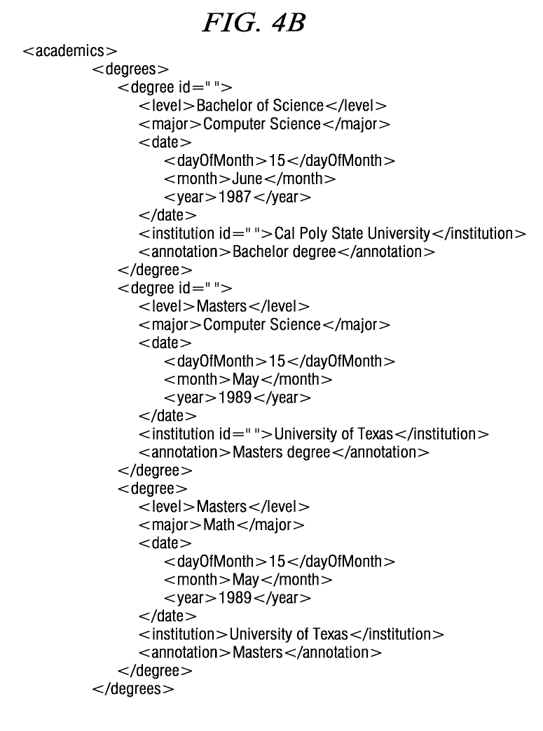

As indicated above, stored resume data 304 preferably includes all of the information that an individual might want to include in a resume. For example, stored resume data 304 typically includes the job applicant's name, address, phone numbers, educational background, work experience, hobbies, rewards, patents and other information that might be of interest to a prospective employer. Usually, the stored resume data will include significantly more information than any single resume that will be created from the stored resume data. FIGS. 4A and 4B illustrate examples of portions of annotated XML resume data according to an illustrative embodiment. In particular, FIG. 4A illustrates annotated stored resume data relating to an individual's work experience that might be included in a resume, and FIG. 4B illustrates annotated stored resume data relating to the individuals' educational background that might be included in a resume.

Rules 308 define the parameters by which a particular resume is to be created. In the illustrative embodiment shown in FIG. 3, rules 308 include content rules 308a specifying the information that is to be included in the resume, such as the type of prior work experience and educational background to be included in the resume; ordering rules 308b specifying a priority of one type of resume data over another to better emphasize certain data over other data, for example, to emphasize one type of prior job experience over another; format rules 308c, specifying physical requirements of the resume, such as its length and the way it is organized; and threshold rules 308d, specifying that a resume meet certain minimum requirements with respect to one or more matters before the resume is created or sent to a prospective employer.

Metadata 306 assists engine 310 in creating a desired resume from stored resume data 304 pursuant to rules 308. The manner in which this may be accomplished can best be understood with reference to the following examples describing the creation of a resume.

For example, consider that an individual may be experienced in both C programming and Java™ programming, but is interested in applying for a position with a company that values C programming ability over Java™ programming ability. The individual, accordingly, wishes to create a resume that emphasizes his/her expertise in C programming. To do so, the individual may specify in rules 308 that C programming experience should be emphasized over Java™ programming experience (ordering rules 308b), or that only C programming experience should be included in the resume (content rules 308a). Metadata 306 is able to identify the previous work experience among all the work experience included in stored resume data 304 that involves C programming experience and Java™ programming experience so that engine 310 can create a resume for that particular job position that emphasizes C programming experience such as by listing it first in a listing of job experience, or that lists only C programming experience depending on the rules that have been specified.

As another example, consider that a prospective employer values recent job experience over earlier job experience. Rules 308 might specify that recent experience be presented first in the resume to be created (ordering rules 308b) or that only job experience after a particular date be included in the resume to be created (content rules 308a), and the metadata will assist in identifying the proper job experience in stored resume data 304 to be included in the resume.

Metadata 306 can also be used to highlight one or more specific aspects of a resume. For example, consider that an individual applied for a job awhile ago, and that the prospective employer was particularly impressed with the individual's prior Americorps experience. The individual was accepted to this job based on the positive feedback regarding the Americorps experience, but the individual is now looking for a new job. The rules can specify that matters relating to the prior Americorps experience be included in a resume to be created irrespective of other rules that may be specified, and the metadata will assist in including this information in the resume.

Yet another example of metadata usage is to ensure that a resume satisfy rules relating to physical requirements of the resume. For example, the rules (format rules 308c) could specify that the resume fit on exactly one page, or on no more than two pages. The metadata can assist in selecting the most important information among all the information in stored resume data 304 to include in the resume while satisfying the length requirements.

In general, metadata 306 aids rules specified by the user (or by another entity authorized by the user) to create the best possible resume for a particular job application, and to provide the user with a certain level of control over a resume to be created.

As indicated above, rules 308 may specify physical requirements of a particular resume to be created. For example, some companies or government organizations may require information to be presented in a resume in a certain format, and format rules 308c will ensure that the created resume is in a proper format. As another example, rules 308 may specify that only a certain number of prior jobs (e.g. the top five prior jobs) be listed in a particular resume to be created, and that other jobs that may be included in the stored resume data not be listed in the resume in order to better emphasize important prior jobs or to reduce the size of the resume. Metadata 306 will assist in identifying these most recent jobs from the resume data to include in the resume.

Rules 308 may also include rules which specify other requirements of a resume to be created for a particular job application. For example, it may be necessary that a resume evidence a certain level or type of experience in order to be even considered by a prospective employer. Threshold rules 308d, accordingly, might specify a certain threshold relating to a particular aspect of the resume that must be satisfied before the resume is created or before it is sent to a prospective employer. This capability can save time and effort to both the job applicant and the prospective employer.

Rules 308 may also include rules which specify that a resume be checked to ensure that information required for a particular job application is included in a resume to be created. For example, if required information is not present in stored resume data 304, the user is prompted to supply the information so that it can be included in the created resume.

Rules 308 may also include rules relating to general aspects of good resume writing. For example, there may be rules relating to “spellchecking” last names, company names or other words that a conventional spellchecker might stumble on. A supplemental dictionary 314 can be included in system 300 and used by engine 310 to cover these words as shown in FIG. 3. A thesaurus 316 can also be included in system 300 and used by engine 310 to ensure that a user uses the same terminology in a resume for a particular job application to describe his/her prior job and/or educational experience that has been used by a prospective employer in describing the job requirements, as it is often desirable that a resume use the same terminology used by the prospective employer with regard to such matters.

According to an illustrative embodiment, rules 308 can be specified by the user (job applicant) for whom the resume is being created. Alternatively, rules 308 can be hosted on another medium, such as a server to which the user sends the resume to be appropriately created. For example, a company might submit resumes to prospective employers on behalf of individual job seekers. The company would generate an appropriate resume based on the prospective employer's profile. In this illustrative embodiment, accordingly, the company itself is hosting rules available for different jobs. These rules may differ for different employers and may result in the generation of different resumes from the same resume data. In general, in the illustrative embodiments, multiple versions of a resume can be easily generated merely by defining different rules pursuant to which engine 310 is to create the different versions.

According to an illustrative embodiment, rules 308 may be generated, at least in part, by system 300 based on a description of a desired position at a desired employer. That is, rather than having the user, a prospective employer or another entity specify the rules, rules 308 can be generated by system 300 from an analysis of an advertisement for a particular job.

To create an appropriate resume for a particular job application, engine 310 reads through stored annotated XML document 302 and creates a “customized” resume 312 from stored resume data 304 and metadata 306 pursuant to rules 308 specified for that particular job application. Stated more specifically, an individual seeking a particular position with a prospective employer, and desiring to present a resume to the prospective employer that best illustrates his/her suitability for the particular job position, can define a set of rules, or obtain a set of rules from another source, specifying the order of importance of prior work experience, prior education and other matters pertinent to that particular position. Engine 310 then creates resume 312 from the stored resume data and metadata pursuant to the specified rules to present the individual's prior work experience, prior education, etc. in the resume in the best possible manner.

Metadata 306, in general, provides the user with some control in deciding what stored resume data should be ignored or emphasized when creating a particular resume. The metadata is used to annotate the resume data to provide the necessary information to generate the desired resume from the resume data. For example, certain work experience among the work experience included in the resume data can be annotated as being in the medical field. When a rule is applied that places importance on experience in the medical field, the relevant work experience will be included in the resume. Additionally, a rule may state that some number of years experience in a particular field is necessary to apply for a particular job. When this rule is applied, the system will look over all the work experience flagged as relevant to a particular field and will be able to tell if the applicant meets the minimum requirements for the job.

An important aspect of the illustrative embodiments is that information to be included in a resume can be easily updated or otherwise changed simply by changing the stored resume data. This capability becomes particularly important when the change involves information that would be common to all versions of a resume, such as the individual's address or phone number. For example, by changing the individual's address only once in the stored resume data, all versions of the resume generated thereafter will contain the correct address.

According to a further illustrative embodiment, a webservice that contains information about employers and specific types of jobs can be provided and accessed by an individual seeking a job. This information can be associated with metadata that engine 310 can use to create an appropriate resume without it being necessary for the individual to create his/her own rules for the engine to use. For example, an individual can query the webservice for a particular company, and the webservice would return keywords (such as C#, NET, etc.), and an appropriate resume would be generated having traits that best represent what that particular company is seeking.

Even if a webservice is used to create a resume for an individual, it may be desirable to include a mechanism to enable the individual to have some degree of control over the resume generation. For example, the individual may want to ensure that a resume not be sent to a previous or current employer. Also, the individual might wish to specify salary range, job location or other characteristics that the webservice will take into consideration when generating resumes. This can be done by including in the resume data and accompanying metadata, a list of companies the job applicant is not interested in, as well as a desired salary range, location and any other number of characteristics that affect what jobs a person is interested in, but would not normally be included in a resume.

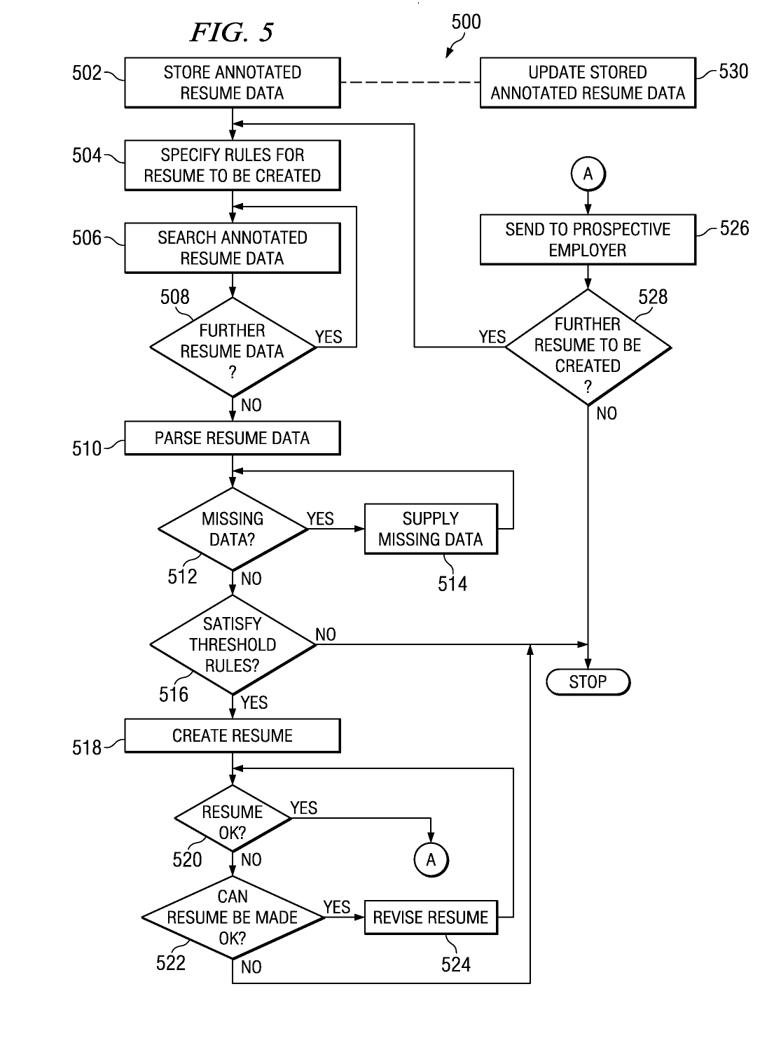

FIG. 5 is a flowchart that illustrates a method for creating a resume according to an illustrative embodiment. The method is generally designated by reference number 500, and begins by storing resume data, annotated by metadata, that includes all the resume information that an individual may wish to include in a resume (Step 502). A set of rules is then specified by which a resume is to be created for a particular job application (Step 504). The set of rules may be specified by an individual or provided from a webservice or another entity, and may include rules relating to the content of the resume, the ordering of information in the resume, the format of the resume and one or more minimum threshold requirements for the resume. The stored annotated resume data is then searched to identify specified resume data to be included in the resume (Step 506). The search is conducted based on content rules specified for the resume to be created. A determination is made whether there is further stored resume data to be searched (Step 508). If there is further resume data to be searched (Yes output of Step 508), the method returns to Step 506. If there is no further resume data to be searched (No output of Step 508), the stored resume data is parsed to provide the specified resume data to be included in the resume to be created (Step 510).

Before the resume is created, however, a determination is made whether there is missing data that should be included in the resume, for example, information that is required by the prospective employer for whom the resume is being created (Step 512). If data is missing (Yes output of Step 512), a prompt is made for the user to supply the missing data (Step 514), and the method returns to Step 512. If there is no missing data (No output of Step 512), a determination is made whether the specified data to be included in the resume meets threshold requirements for the particular job being sought (Step 516). If threshold requirements are not met (No output of Step 516), the resume is not created and the method ends. If threshold requirements are satisfied (Yes output of Step 516), the resume is created from the specified resume data (Step 518). The resume is created pursuant to the specified ordering and format rules to provide an effective resume for the particular job being sought. (It should be noted that the determination of whether threshold requirements are satisfied can also be made after the resume is created, if desired.)

Before the created resume is actually sent to a prospective employer, the job applicant is preferably given an opportunity for final review and approval of the resume (Step 520). This capability is particularly important when the resume is created by an entity other than the job applicant. If the created resume is not satisfactory (No output of Step 520), a determination is made if the resume can be made satisfactory (Step 522), for example, by changing the rules. If the resume can be made satisfactory (Yes output of Step 522), a revised resume is created (Step 524), and the method returns to Step 520. If the resume cannot be made satisfactory (No output of Step 522), the resume is not sent to the prospective employer and the method ends. If the resume is satisfactory (Yes output of Step 520), it is sent to the prospective employer (Step 526).

A determination is then made if another resume is to be created, e.g., for another job application (Step 528). If another resume is to be created (Yes output of Step 528), the method returns to Step 504 to specify a set of rules by which the additional resume is to be created. The specified set of rules may be the same as or different from the set of rules specified for the previously created resume. If no further resume is to be created (No output of Step 528), the method ends.

As illustrated by Step 530, the stored annotated resume data can be updated or otherwise changed at any time, and any resume created after the change will reflect the changed information.

The illustrative embodiments thus provide a computer implemented method, system and computer program product for creating a resume that facilitates generating and updating multiple versions of the resume. A computer implemented method for creating a resume includes storing resume information. Rules are specified by which a resume for a particular job application is to be created, and the stored resume information is parsed according to the specified rules to provide specified resume information. A resume is then created for the particular job application from the specified resume information.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for creating a resume, comprising:
storing resume information;
specifying rules by which a resume for a particular job application is to be created;
parsing the stored resume information according to the specified rules to provide specified resume information; and
creating the resume for the particular job application from the specified resume information.

2. The computer implemented method according to claim 1, wherein storing resume information comprises:
storing annotated resume data.

3. The computer implemented method according to claim 2, wherein storing annotated resume data comprises:
storing an annotated XML document that includes stored resume data, and metadata about the stored resume data.

4. The computer implemented method according to claim 1, wherein specifying rules by which a resume for a particular job application is to be created comprises:
responsive to user input, storing job applicant specified rules by which the resume for a particular job application is to be created.

5. The computer implemented method according to claim 1, wherein specifying rules by which a resume for a particular job application is to be created comprises:
a webservice specifying the rules by which the resume for a particular job application is to be created, wherein the webservice creates the resume for the particular job application from the stored resume information pursuant to the specified rules.

6. The computer implemented method according to claim 1, wherein parsing the stored resume information according to the specified rules to provide specified resume information, comprises:
searching the stored resume information; and
identifying the specified resume information to be included in the resume for the particular job application pursuant to the specified rules.

7. The computer implemented method according to claim 1, and further comprising:
updating the stored resume information to reflect a change in the stored resume information.

8. The computer implemented method according to claim 1, wherein specifying rules by which a resume for a particular job application is to be created, comprises:
specifying a set of rules for each of a plurality of different job applications by which a resume for each of the plurality of different job applications is to be created; wherein parsing the stored resume information according to the specified rules to provide specified resume information comprises:
parsing the stored resume information for each of the plurality of different job applications according to the set of rules specified for each of the plurality of different job applications; and wherein creating the resume for the particular job application from the specified resume information, comprises:
creating a resume for each of the plurality of different job applications from the specified resume information for each of the plurality of different job applications.

9. The computer implemented method according to claim 1, wherein specifying rules by which a resume for a particular job application is to be created, comprises:
specifying rules relating to content of the resume, a content order for the resume, and a format for the resume.

10. The computer implemented method according to claim 1, wherein specifying rules by which a resume for a particular job application is to be created, comprises:
specifying minimum threshold requirements for the resume to be sent to a prospective employer.

11. A system for creating a resume, comprising:
a storage for storing resume information;
a mechanism for specifying rules by which a resume for a particular job application is to be created; and
an engine for parsing the stored resume information according to the specified rules to provide specified resume information, and for creating the resume for a particular job application from the specified resume information.

12. The system according to claim 11, wherein the stored resume information comprises stored annotated resume data.

13. The system according to claim 12, wherein the stored annotated resume data comprises an annotated XML document that includes resume data, and metadata about the resume data.

14. The system according to claim 11, and further comprising:
a mechanism for updating the stored resume information to reflect a change in the stored resume information.

15. A computer program product, comprising:
a computer usable medium having computer usable program code for creating a resume, the computer program product comprising:
computer usable program code configured for storing resume information;
computer usable program code configured for specifying rules by which a resume for a particular job application is to be created;
computer usable program code configured for parsing the stored resume information according to the specified rules to provide specified resume information; and
computer usable program code configured for creating the resume for the particular job application from the specified resume information.

16. The computer program product according to claim 15, wherein the computer usable program code configured for storing the resume information comprises:
computer usable program code configured for storing annotated resume data.

17. The computer program product according to claim 16, wherein the computer usable program code configured for storing annotated resume data comprises:
computer usable program code configured for storing an annotated XML document that includes resume data and metadata about the stored resume data.

18. The computer program product according to claim 15, wherein the computer usable program code configured for parsing the stored resume information according to the specified rules to provide specified resume information, comprises:
computer usable program code configured for searching the stored resume information; and
computer usable program code configured for identifying the specified resume information to be included in the resume for the particular job application pursuant to the specified rules.

19. The computer program product according to claim 15, and further comprising:
computer usable program code configured for updating the stored resume information to reflect a change in the stored resume information.

20. The computer program product according to claim 15, wherein the computer usable program code configured for specifying rules by which a resume for a particular job application is to be created, comprises:
computer usable program code configured for specifying a set of rules for each of a plurality of different job applications by which a resume for each of the plurality of different job applications is to be created; wherein the computer usable program code configured for parsing the stored resume information according to the specified rules to provide specified resume information comprises:
computer usable program code configured for parsing the stored resume information for each of the plurality of different job applications according to the set of rules specified for each of the plurality of different job applications; and wherein the computer usable program code configured for creating the resume for the particular job application from the specified resume information, comprises:
computer usable program code configured for creating a resume for each of the plurality of different job applications from the specified resume information for each of the plurality of different job applications.
